(19) United States
(12) Patent Application Publication
(10) Pub. No.: US 2014/0157744 A1
(43) Pub. Date: Jun. 12, 2014

(54) Mounted Leaf Blower Platform

(71) Applicant: Thomas E. Anderson, Irmo, SC (US)

(72) Inventor: Thomas E. Anderson, Irmo, SC (US)

(21) Appl. No.: 14/101,534

(22) Filed: Dec. 10, 2013

Related U.S. Application Data
(60) Provisional application No. 61/736,141, filed on Dec. 12, 2012.

(51) Int. Cl. A01D 43/00

(52) U.S. Cl. CPC A01D 43/00
USPC 56/13.5

(57) ABSTRACT

A vehicle mounted leaf blower support platform is provided. The present invention comprises a substantially flat support surface, a vertical back surface to which an attachment arm is adjustably affixed, a pair of securement arms and a support bar for removably holding a conventional leaf blower in place, and a tube holder for ideally positioning the nozzle of the leaf blower supported thereon. The present invention is removably affixed to the rear portion of a riding lawnmower, or other similar vehicle, so that grass clippings and other lawn debris generated by the lawnmower is automatically blown away as the lawnmower travels across the yard by the leaf blower supported by the present invention.

### CROSS REFERENCE TO RELATED APPLICATION

This application claims the benefit of U.S. Provisional Application No. 61/736,141 filed on Dec. 12, 2012. The above identified patent application is herein incorporated by reference in its entirety to provide continuity of disclosure.

### BACKGROUND OF THE INVENTION

1. Field of the Invention

The present invention relates to leaf blowers. More specifically, the present invention relates to riding lawnmower mounts that are adapted to support leaf blowers.

Although leaf blowers provide a means for cleaning a yard that is much simpler and easier than raking, carrying a heavy leaf blower around outside in the sun for extended periods of time can nonetheless be very uncomfortable and tiring. Furthermore, cleaning up after cutting one's lawn is generally a very tedious and unenjoyable task. It is also extremely inefficient to mow an entire lawn, put the equipment used to mow the lawn away, retrieve a new set of equipment, and then have to clean up the yard with the new set of equipment. It would be much simpler and more efficient for individuals to have access to a device that automatically and simultaneously cleaned their yard while they mowed it.

Current devices include various types of mounts for leaf blowers or wheeled fan devices intended to make cleaning up grass clippings and other lawn debris easier. Such devices include a wheeled housing upon which one can secure his or her leaf blower. The user can then turn on his or her leaf blower and then simply pushing the wheeled housing structure, rather than being forced to carry the leaf blower around. Although the user does not need to physically carry the leaf blower, these devices are still inefficient because mowing the lawn and cleaning up the resulting lawn debris are still separate activities. Furthermore, these wheeled housing units are not ideally suited for being pushed across the bumpy, uneven surface of a lawn. Other devices include wheeled fan apparatuses, but these suffer from many of the same problems as the above mentioned devices, including an undesirable lack of efficiency. Furthermore, these types of devices do not allow the user to use his or her own conventional leaf blower. Therefore, there is a need for a device that allows users to use their own leaf blower and also simultaneously clean up law debris while they mow their lawn.

The present invention provides a leaf blower support platform that removably affixes to the rear end of a riding lawnmower. The platform has a versatile design that adjustably supports any type of handheld or backpack leaf blower. Because the present invention supports a conventional leaf blower, there is no need to purchase a new leaf blower device. The present invention is positioned behind the riding lawnmower so that grass clippings are blown away by the leaf blower as they are created by the riding lawnmower. The present invention maximizes efficiency because it automatically cleans up a yard while mowing, without the need to take separate action to remove the grass clippings or other debris.

2. Description of the Prior Art

Devices have been disclosed in the prior art that relate to mounted or movable leaf blowers. These include devices that have been patented and published in patent application publications. These devices generally relate to wheeled housing assembles that are adapted to support a leaf blower. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 5,090,088 to Toth, which discloses a leaf blower apparatus mounted to a deck having a plurality of wheels and a handle extending therefrom. The wheels of Toth are adjustable so that the position of the leaf blower may be optimized depending on the given circumstances. The present invention differs from Toth in several key respects. One of the differences is that the present invention comprises a mount for a conventional backpack leaf blower, rather than a separate leaf blower apparatus. Another difference is that although the present invention is also height-adjustable, it utilizes a system of notches disposed at varying heights across the back surface of the device to set the height of the device, not adjustable wheels.

Another such device is U.S. Pat. No. 6,009,595 to Leasure, which discloses a vegetation debris blower and cart assembly. The device comprises a cart that has a pair of wheels and is adapted to removably secure a handheld leaf blower in place. Like the present invention, Leasure is a support framework designed to removably hold a conventional leaf blower in order to make it easier to use the leaf blower. However, the present invention comprises a support frame that is designed to be affixed to the rear portion of a riding lawnmower, rather than being designed to be moved itself. Furthermore, the present invention includes a support member for holding the leaf blower tube and ensuring that the airflow from the leaf blower is properly directed at all times.

U.S. Pat. No. 6,185,917 to Goudes discloses a utility cart that is capable of transporting and supporting a landscaping appliance, such as a leaf blower. Goudes comprises a rectangular base, a plurality of wheels mounted to the base, a retaining arm pivotally mounted to the base, and a handle. The present mounted leaf blower platform also utilizes a support bar to keep the leaf blower in place during use, however, the support bar of the present invention is adjustably disposed between a pair of securement arms, rather than being pivotally mounted to the base portion. Furthermore, as with Leasure, the present invention is adapted to be affixed to the rear portion of a riding lawnmower and as such does not have any wheels or any form of locomotion integrated into the design of the device.

Finally, U.S. Pat. No. 6,226,833 to Kawaguchi discloses a transportable leaf blower apparatus comprising a movable support framework, a leaf blower that is swingably supported on the movable support, a discharge pipe attached to the blower, and a motor for driving the blower. In Kawaguchi the leaf blower is integrally connected to the device, whereas the present invention comprises a support framework that is capable of removably supporting a conventional leaf blower.

The present invention provides a support platform for a leaf blower that mounts to the rear portion of a riding lawnmower, or another such vehicle. The present invention comprises a substantially vertical member and a substantially horizontal base member that attach to form a roughly L-shaped configuration. An attachment arm extends from the back member to removably secure the present invention to the rear end of a vehicle. A conventional backpack leaf blower is supported by the base member and is removably held in place by a pair of securement arms extending from the back member. A semi-tubular leaf blower nozzle holder extends from the base member and is adapted to properly direct the airflow exiting the leaf blower so that it blows away the freshly cut grass clippings generated by the attached lawnmower to which the present invention is secured. It substantially diverges in design elements from the prior art and consequently it is clear that there is a need in the art for an improvement to existing mounted leaf blower support devices. In this regard the instant invention substantially fulfills these needs.

### SUMMARY OF THE INVENTION

In view of the foregoing disadvantages inherent in the known types of lead blower support apparatuses now present in the prior art, the present invention provides a new lead blow support mount wherein the same can be utilized for providing convenience for the user when mowing one's lawn with a riding lawnmower.

It is therefore an object of the present invention to provide a new and improved mounted lawnmower support device that has all of the advantages of the prior art and none of the disadvantages.

It is another object of the present invention to provide a mounted leaf blower support device that attaches to the rear portion of a riding lawnmower, or other similar vehicle.

Another object of the present invention is to provide a mounted leaf blower support device that directs airflow from the leaf blower supported thereon so that grass clippings are blown away immediately after they are cut by the riding lawnmower.

Yet another object of the present invention is to provide a mounted leaf blower platform that is able to support a conventional handheld or backpack leaf blower.

Yet another object of the present invention is to provide a mounted leaf blower platform that is adjustable and capable of supporting various sized leaf blowers.

Yet another object of the present invention is to provide a mounted leaf blower platform that is height-adjustable so that the airflow from the leaf blower may be directed to different positions.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a perspective view of the present invention as it is attached to the rear portion of a riding lawnmower, along with a call out showing the attachment means.

FIG. 3 shows a perspective view of the present invention attached to the rear portion of a riding lawnmower and with a leaf blower supported thereon.

### DETAILED DESCRIPTION OF THE INVENTION

Reference is made herein to the attached drawings. Like reference numerals are used throughout the drawings to depict like or similar elements of the mounted leaf blower platform. For the purposes of presenting a brief and clear description of the present invention, the preferred embodiment will be discussed as used for supporting a conventional backpack leaf blower on the rear portion of a riding lawn mower. The figures are intended for representative purposes only and should not be considered to be limiting in any respect.

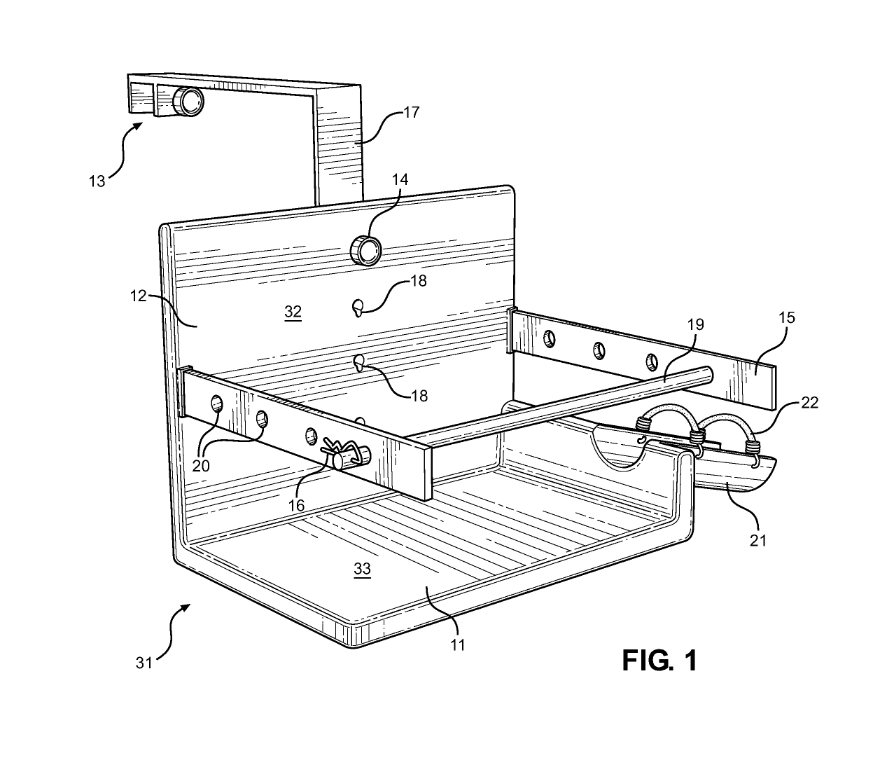

Referring now to FIG. 1, there is shown a perspective view of the present invention. The present mounted leaf blower platform comprises a substantially vertical member 12 and a substantially horizontal base member 11 that are attached in a roughly L-shaped configuration, forming a support platform 31. The support platform 31 may be composed of any type of material, but is preferably composed of hard plastic. In the depicted embodiment, the back member 12 and the base member 11 are rectangular in shape, but no claim is made as to the exact shape of the members 11, 12. The support platform 31 has a contiguous, substantially flat upper surface formed by the front surface 32 of the vertical member 12 and the upper surface 33 of the base member 11. The support platform 31 is designed to support a conventional handheld or backpack leaf blower thereon.

The present invention further comprises an attachment arm 17 having a first end and a second end. An attachment means 13 is disposed on the first end of the attachment arm. The attachment means 13 is provided in order to removably affix the present mounted leaf blower platform to the rear portion of a riding lawn mower. In the depicted embodiment the attachment means 13 comprises a C-clamp-like configuration, but no claim is made as to the exact structure of the attachment means 13. The attachment arm 17 is depicted in a roughly L-shaped configuration, but no claim is made as to its shape, as long as it is capable of supporting the present invention in position on the rear portion of a riding lawnmower. The attachment arm 17 is preferably composed of a metal material in order to support the weight of a leaf blower.

The vertical member 12 has a plurality of aligned height apertures 18 extending therethrough. Although no claim is made as to the exact size and configuration of the height apertures 18, they are preferably aligned vertically in the center of the vertical member 12 so that the present invention is properly balanced when a leaf blower is supported thereon. The second end of the attachment arm 17 is affixed to the support platform 31 through one of the height apertures 18 and is secured in place by a height fastener 14. The user can vary the height of the support platform 31 relative to the riding lawnmower to which it is attached by changing the height aperture 18 through which the height fastener 14 and second end of the attachment arm 17 are connected. The height fastener 14 may comprise any means of reversibly affixing the attachment arm 17 in place, including, but not limited to, a knob having a threaded portion that engages with a corresponding threaded aperture on the second end of the attachment arm 17.

The support platform 31 further has a pair of securement arms 15 extending from opposite sides of the front surface 32. The securement arms 15 have a plurality of aligned bar adjustment apertures 20 and a support bar 19 extending through a pair of aligned bar adjustment apertures 20 between the securement arms 15. The diameter of the bar adjustment apertures 20 roughly matches the diameter of the support bar 19, such that the support bar 19 can extend through the bar adjustment apertures 20, but is simultaneously firmly held in place during use. One end of the support bar 19 has a removable locking pin 16 and the opposing end has a stopping means. The locking pin 16 and the stopping means work in tandem to prevent the bar from being pulled from the securement arms 15 while the present invention is in use. The locking pin 16 may be removed, allowing the bar to be removed so that a leaf blower can be placed on the support platform 31. Otherwise, the support bar 19 extending between the securement arms 15 would block a leaf blower from being placed in position.

The securement arms 15 and the support bar 19 keep the leaf blower supported on the support platform 31 in place during use. The securement arms 15 are disposed at a height such that they block a leaf blower supported on the support platform 31 from falling off of the sides of the device from the movement of the vehicle, vibrations from the vehicle or from the leaf blower itself, or due to any other reason. The securement arms 15 may be composed of any material, but are preferably composed of metal.

The present mounted leaf blower platform further has a tube holder 21 extending from one of the sides of the base member 11. The tube holder 21 is adapted to hold the nozzle portion of a leaf blower and thereby direct the air expelled therefrom so that freshly cut grass clippings generated by the riding lawnmower are blown away by the leaf blower. The tube holder 21 is a semi-tubular or gutter shape so that a leaf blower nozzle can be supported thereon. Furthermore, there are a plurality of tube securement means 22 disposed on the tube holder 21 to hold the leaf blower nozzle in place. In the depicted embodiment, the tube securement means 22 comprises a pair of hooked straps extending across the supper surface of the tube holder 21, but no claim is made as to the specific configuration of the tube securement means 22. The tube securement means 22 are provided to hold the leaf blower nozzle in place during use so that the nozzle does not become dislodged at any point, which would ruin the effectiveness of having a leaf blower trailing behind the riding lawnmower, blowing away the grass clippings.

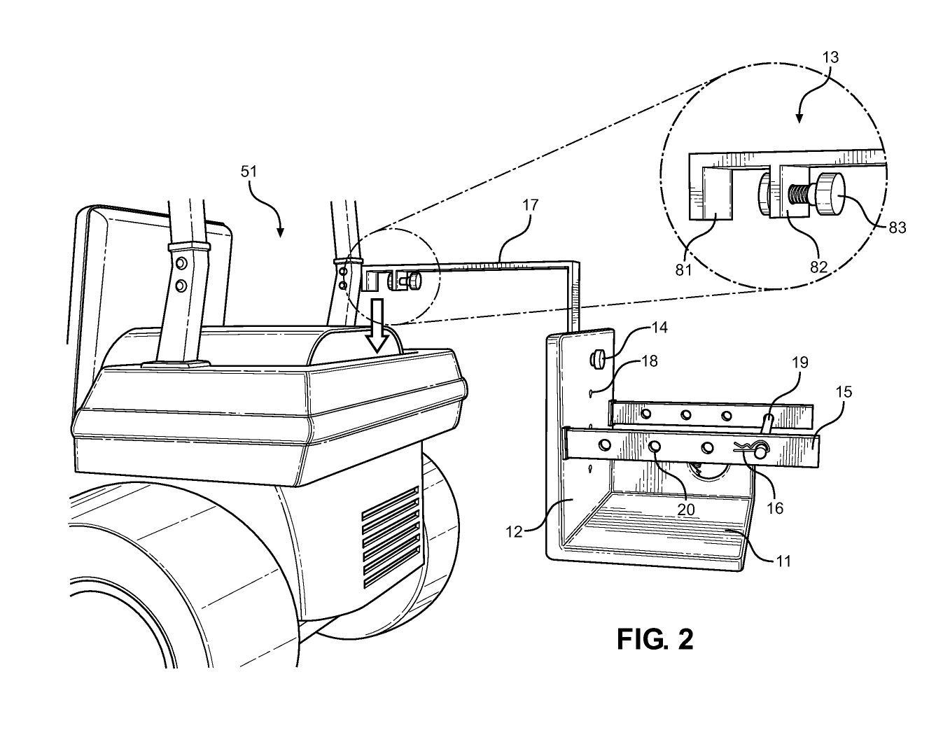

Referring now to FIG. 2, there is shown a perspective view of the present invention as it is attached to the rear portion of a riding lawnmower, along with a call out showing the attachment means. The present invention is depicted as attaching to a zero turn riding lawnmower 51, but the device may be designed to affix to any type of riding lawnmower or other similar vehicle. The attachment means 13 of the depicted embodiment comprises a C-clamp-like configuration wherein the edge of the rear portion of the riding lawnmower 51 is placed between the flanges 81, 82 and then the fastening means 83 is tightened until the edge of the riding lawnmower 51 is secured between the first flange 81 and the fastening means 83, holding the present mounted leaf blower platform in place.

The present invention is attached to the rear portion of the riding lawnmower 51 so that the leaf blower supported thereon can blow away the grass clippings generated by the riding lawnmower 51 soon after they are created. As the riding lawnmower 51 travels across the user's lawn, cutting grass, grass clippings are expelled from one side of the riding lawnmower 51. The leaf blower, supported by the present invention, follows the riding lawnmower 51 and blows away the resulting grass clippings, obviating the need for the user to return at a later time and clean up the grass clippings himself or herself. The present invention can also be used without the riding lawnmower cutting grass. Leaves, branches, and other lawn debris can be simply and easily cleaned up by driving the riding lawnmower 51, without the cutting blades engaged and with the present invention and a leaf blower mounted thereon, past the debris. Therefore, it is not necessary to walk around and manually use a leaf blower to clean a yard; the user can instead merely affix the leaf blower to the vehicle using the present invention and merely drive around cleaning up the yard.

The present invention can accommodate leaf blowers of various sizes and configurations in a number of different ways. First, the support bar 19 can be placed through different pairs of aligned bar adjustments apertures 20 in order to securely hold different sized leaf blowers in place. Second, the height of the entire device can be adjusted by changing which height aperture 18 the attachment arm 17 and the height fastener 14 are affixed together through. It is advantageous to have the ability to adjust the height of the present invention relative to the riding lawnmower 51 because it allows the user to adjust the angle and positioning of the tube holder, which guides the leaf blower nozzle. Therefore, the user is able to ideally position the leaf blower nozzle to maximize the amount of grass clippings or other debris that are blown away.

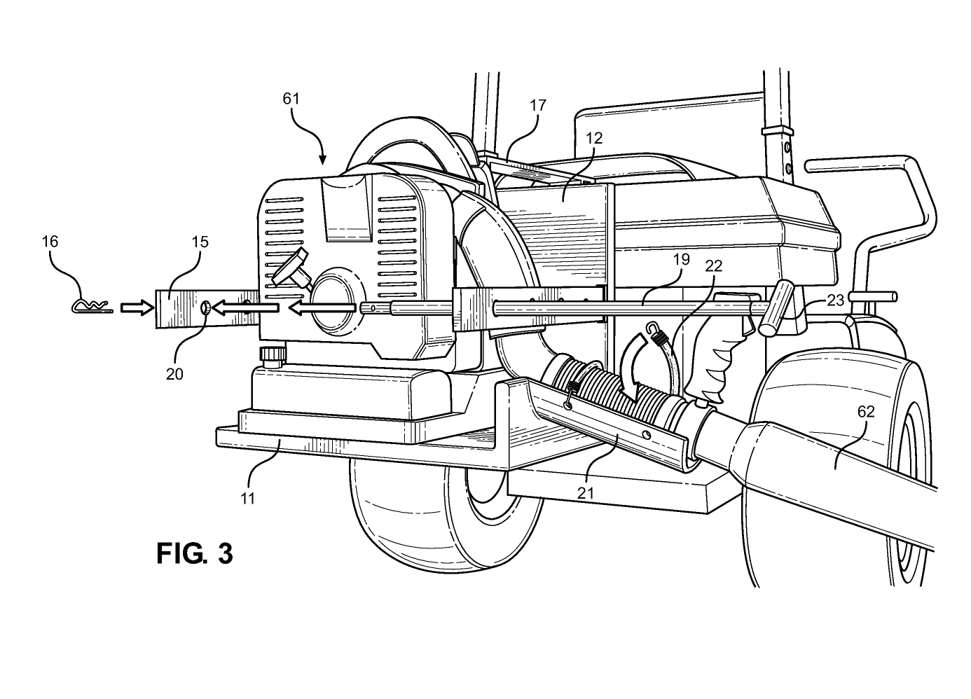

Referring now to FIG. 3, there is shown a perspective view of the present invention attached to the rear portion of a riding lawnmower and with a leaf blower supported thereon. The present mounted leaf blower platform is designed to support any conventional handheld or backpack leaf blower 61. The present invention only relates to the means for removably supporting the leaf blower 61 on the rear portion of a riding lawnmower, or similar vehicle, and the leaf blower 61 itself is not a claimed element of the present invention.

In use, the leaf blower 61 is placed on the base member 11 between the securement arms 15 and is removably secured in place by inserting the support bar 19 through a pair of aligned bar adjustment apertures 20. The support bar 19, the securement arms 15, and the vertical member 12 enclose the leaf blower 61 on all four sides, limiting the movement of the leaf blower so that it is not unduly jostled or does not fall off of the present invention during use. The support bar 19 is reversibly locked in place by the locking pin 16. The locking pin 16 in the depicted embodiment has a bobby pin-like configuration, but not claim is made as to the exact design of the locking pin 16. The locking pin 16 is provided only to removably secure the end of the support bar 19 that is opposite from the stopping means 23. The user then affixes the leaf blower nozzle 62 in place using the tube securement means 22 affixed on the tube holder 21. Once the leaf blower 61 is securely stowed, the user then turns it on and then uses the riding lawnmower as normal. As grass clippings are expelled from the riding lawnmower, the leaf blower 61 automatically blows them away, automatically cleaning the yard.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A leaf blower mount adapted to attach to the rear end of a riding lawnmower, comprising:
a support platform having a vertical member and a base member;
a fastening means attached to said vertical member and adapted to secure said support platform to a riding lawnmower;
a tube holder attached to said base member and adapted to removably hold a leaf blower nozzle;
a securement means attached to said support platform and adapted to removably secure a leaf blower in place on said support platform.

2. The leaf blower mount of claim 1, wherein said fastening means comprises an attachment arm having a first end and a second end, said first end connected to an attachment means and said second end adjustably connected to said vertical member.

3. The leaf blower mount of claim 2, wherein said attachment means comprises a C-clamp.

4. The leaf blower mount of claim 1, wherein said securement means comprises a pair of securement arms extending from said vertical member, said securement arms having a plurality of aligned bar adjustment apertures and a support bar removably extending between said aligned bar adjustment apertures.

5. The leaf blower mount of claim 3, further comprising a locking pin removably attached to said support bar and adapted to prevent said support bar from being pulled through said aligned bar adjustment apertures.

6. The leaf blower mount of claim 1, further comprising a tube securement means attached to said tube holder and adapted to removably hold said leaf blower nozzle in place within said tube holder.

7. The leaf blower mount of claim 5, wherein said tube securement means comprises a plurality of straps removably attached to said tube holder.

8. A leaf blower mount adapted to attach to the rear end of a riding lawnmower, comprising:
a support platform having a vertical member and a base member;
a plurality of height adjustment apertures disposed on said vertical member, said height adjustment apertures being vertically aligned;
an attachment arm having a first end and a second end, said first end connected to an C-clamp and said second end adjustably connected to said vertical member through said height adjustment apertures;
a tube holder attached to said base member and adapted to removably hold a leaf blower nozzle;
a tube securement means attached to said tube holder and adapted to removably hold said leaf blower nozzle in place within said tube holder;
a pair of securement arms extending from said vertical member, said securement arms having a plurality of aligned bar adjustment apertures and a support bar removably extending between said aligned bar adjustment apertures;
said support bar having a first bar end and a second bar end, said first bar end having a blocking means attached thereto for preventing said support bar from being pulled through said bar adjustment apertures and said second bar end having a locking pin removably attached thereto for preventing said support bar from being pulled through said bar adjustment apertures.
